(19) United States
(12) Patent Application Publication
(10) Pub. No.: US 2020/0352262 A1
(43) Pub. Date: Nov. 12, 2020

(54) Protective Hood

(71) Applicant: Bob Barker Company, Inc., Fuquay-Varina, NC (US)

(72) Inventors: Lena Renee Butterfield, Apex, NC (US); Gerrad Stephen Allison, Angier, NC (US)

(21) Appl. No.: 16/867,667

(22) Filed: May 6, 2020

Related U.S. Application Data
(60) Provisional application No. 62/845,507, filed on May 9, 2019.

(51) Int. Cl. A41D 13/11; A62B 17/04; A62B 17/00

(52) U.S. Cl. CPC A41D 13/1153; A62B 17/04; A62B 17/006; A41D 2500/10; A41D 13/1161; A41D 2200/20; A41D 13/1184

(57) ABSTRACT

A protective hood that can be securely positioned on a user's head. The protective hood includes a section that aligns with the user's eyes and provides for them to see through. Another section aligns with the user's mouth and restricts fluids from the user's mouth from passing beyond the section. The protective hood is design to be placed onto the top of the user's head and be pulled over their eyes and mouth.

### RELATED APPLICATIONS

This claims priority to U.S. Provisional Application No. 62/845,507, filed May 9, 2019, the disclosure of which is incorporated herein by reference in its entirety.

### BACKGROUND

It is sometimes necessary to place a hood over a person, such as a suspect or inmate who is in custody. The hood can prevent the person from spitting on others while still allowing for the person to breathe. It is often difficult to place the hood onto the person. The person may not be cooperative and may move or thrash around to prevent a person from placing the hood on the person's head. Further, it may be difficult to properly position the hood on the person. If the hood is not place properly on the person, the hood may not prevent the person from spitting on other nearby persons.

The protective hood may also be used in other contexts, including but not limited to medical situations, painting, and cleaning. The protective hood should fit securely on the head of the user. Further, the protective hood should allow for the person to see and not block their vision.

### SUMMARY

One aspect is directed to a protective hood sized to be positioned over a head of a user. The protective hood comprises a single unitary knitted body with a tubular shape comprising a closed first end and an open second end. An interior space is formed within the body and sized to receive the head of the user. The tubular body comprises a first section with a first knitting pattern and positioned along the body to be aligned with eyes of the user to provide for the user to see when the head of the user is positioned in the interior space. The tubular body comprises a second section positioned between the first section and the second end with the second section comprising a second knitting pattern different than the first section and positioned along the body to be aligned with a mouth of the user to restrict passage of fluids from the mouth of the user through the second section.

In another aspect, the second knitting pattern is denser than the first knitting pattern.

In another aspect, the second section comprises additional material than the first section to restrict the passage of the fluids.

In another aspect, the tubular body further comprises a third section positioned between the first section and the closed end with the third section comprising the second knitting pattern.

In another aspect, the body is constructed from a yarn with 95% nylon and 5% spandex.

In another aspect, the first section extends completely around the interior space.

In another aspect, each of the first and second sections extend completely around the body.

In another aspect, a band is positioned at the second end with the band having a different visual appearance than a remainder of the body.

One aspect is directed to a protective hood sized to be positioned over a head of a user. The protective hood comprises a tubular body configured to receive the head of the user. The body comprises: a first end; an open end opposite from the first end, the open end comprising an edge; and a central section that extends between the edge and the first end and comprises a first section and a second section with the first section having a first construction that is see-through and a second section with a different construction that restricts passage of fluid. The body is movable between a closed orientation and an open orientation. The closed orientation comprises the central section in an overlapping configuration with a length of the body measured between the first end and the edge being a first amount. The open orientation comprises the central section extended in a non-overlapping configuration with the length being greater than the first amount.

In another aspect, the body comprises a unitary construction.

In another aspect, the first section comprises a first knitting pattern and the second section comprises a second knitting pattern different than the first section.

In another aspect, the body comprises a third section that extends between the first section and the first end with the third section comprising a different construction than the first section.

In another aspect, each of the first section and the second section extend completely around the body.

In another aspect, tabs are positioned on opposing sides of the edge with the tabs being exposed in the closed orientation and extending outward beyond the open end.

In another aspect, the second section prevents the passage of fluids from the mouth of the user through the second section.

In another aspect, the first end is closed.

One aspect is directed to a method of using a protective hood on a user that is in an environment. The method comprises: placing the hood on a top of a head of the user with the hood in a rolled orientation; unrolling the hood and positioning a first section of the hood over eyes of the user with the first section having a first construction that allows the user to see through and into the environment; unrolling the hood and positioning a second section of the hood over a mouth of the user with the second section having a different second construction that restricts passage of fluid from the mouth of the user out into the environment; and positioning an open end of the hood below the user's mouth.

In another aspect, the method comprises positioning a third section of the hood at the top of the head of the user with the third section having the same second construction as the second section.

In another aspect, the method comprises expanding a size of an interior space of the hood and unrolling the hood from the top of the head of the user to below the mouth of the user.

In another aspect, the method comprises placing the hood on the top of the head of the user with the hood in the rolled orientation and aligning tabs to extend outward from the hood.

In another aspect, the method comprises positioning the first section completely around the head of the user.

### BRIEF DESCRIPTION OF THE DRAWINGS

FIG. 1 is a perspective view of a protective hood in an open orientation.

FIG. 2 is a perspective view of a protective hood in a closed orientation.

FIG. 3 is a perspective view of a protective hood in a closed orientation and/or a partially closed orientation.

FIGS. 4A-4C are perspective views of a protective hood in an open orientation positioned over a person's head.

FIG. 5A is a perspective view of a protective hood in a closed orientation on top of a person's head.

FIG. 5B is a perspective view of the protective hood of FIG. 5A being pulled over a head of a user.

FIG. 5C is a perspective view of the protective hood of FIG. 5B in an open orientation positioned on the person.

FIGS. 5D-5F are perspective view of the protective hood of FIGS. 5A-5C on the person.

FIG. 6 is a side view of a protective hood in an open orientation and with a band at a second end.

### DETAILED DESCRIPTION

The present application is directed to a protective hood that can be securely positioned on a user's head. The protective hood includes a section that aligns with the user's eyes and provides for them to see through and into their environment in which they are located. Another section aligns with the user's mouth and restricts fluids from the user's mouth from passing beyond the section and into the environment. The protective hood is design to be placed onto the top of the user's head and be pulled over the eyes and mouth.

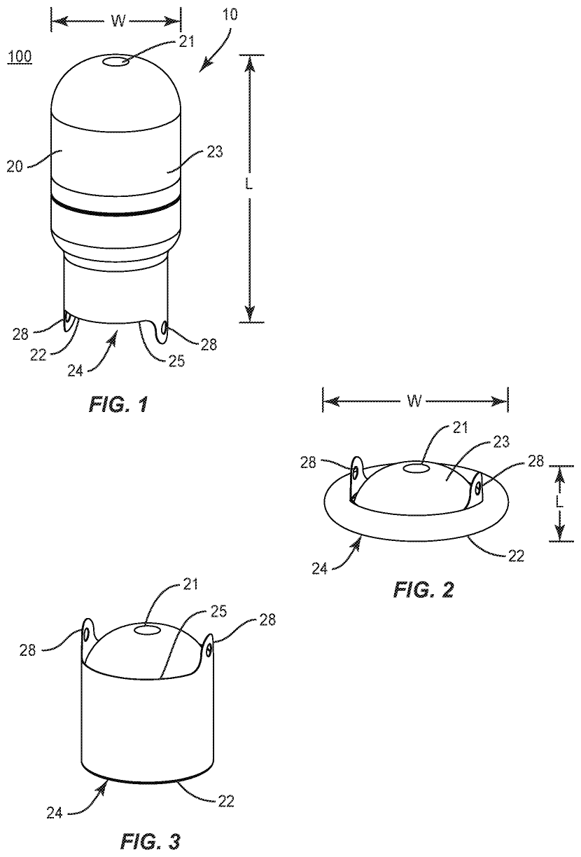

FIG. 1 schematically illustrates a protective hood 10 in an open orientation. The protective hood 10 includes a body 20 with a tubular shape with an interior space 24 sized to receive a person's head. The body 20 includes a first end 21 configured to be aligned with a top of the person's head, and an open second end 22. In the open orientation as illustrated in FIG. 1, the second end 22 is formed at an open edge 25 that is sized to be aligned with the person's neck. The body 20 includes a central section 23 between the first end 21 and the edge 25. The central section 23 is positioned to extend over the eyes and mouth.

In one example, one or more tabs 28 can be positioned at the edge 25. The tabs 28 can provide a handle for a person to grasp and move the protective hood 10 over the person from the closed orientation as illustrated in FIG. 2 to the open orientation as illustrated in FIG. 1. The tabs 28 can be exposed in the closed orientation as illustrated in FIGS. 2 and 3 to be accessible. In one design, tabs 28 are positioned on opposing sides of the body 20.

In another example as illustrated in FIG. 6, a band 27 is positioned at the edge 25. The band 27 is visually distinct from a remainder of the body 20, such as by being a different color or having a different construction. The band 27 remains exposed in the closed orientation and provides a visual indication on how to grasp the body 20 and pull it over the user's head.

In one example as illustrated in FIGS. 1, 2, and 3, the tabs 28 (or band 27 of FIG. 6) are exposed in the closed orientation. This can occur as the body 20 is initially folded as illustrated in FIG. 3. This positions the tabs 28 or band 27 towards the first end 21 of the body 20. The section of the body 20 between the second end 22 and the tabs 28 or band 27 is then rolled to form the closed orientation as illustrated in FIG. 2. The tabs 28 or band 27 are exposed and can be grasped by a user to pull the body 20 over the user's head.

The body 20 can be in various orientations when closed. FIG. 2 illustrates one example of the body 20 in a closed orientation. FIG. 3 can also include the closed orientation. The closed orientation includes the central section 23 in various overlapping configurations, such as but not limited to being folded and being rolled.

In the open orientation as illustrated in FIG. 1, the body 20 includes a length L measured between the ends 21, 22. The length L in the open orientation is sized for the first end 21 to be positioned at the top of the person's head, and the edge 25 at the second end 22 to be positioned below the person's mouth, and preferably at the person's neck. The body 20 further includes a width W measured between opposing lateral sides. In one example, the width W is consistent along the length L. In other examples as illustrated in FIGS. 1 and 6, the width W can also vary along the length L.

The protective hood 10 is sized to extend over the person's head and prevent fluids such as spit and respiratory droplets from passing through the body 20 and into the environment 100. The protective hood 10 can also be configured to allow the person to see through to view the environment 100.

The protective hood 10 can be in a closed orientation prior to being placed onto the person's head. FIG. 2 includes a protective hood 10 in a closed orientation with the body 20 rolled upward from the open edge 25 (edge 25 is within the interior of the rolled body 20 and not visible in FIG. 2). As illustrated in FIG. 2, the rolled orientation includes the edge 25 and at least a portion of the central section 23 rolled inward towards the first end 21. In the rolled orientation, the edge 25 is rolled inward and covered by the body 20. The length L of the protective hood 10 in the closed orientation measured between the ends 21, 22 is smaller than in the open orientation. In some examples, the body 20 is rolled completely through the central section 23 and the second end 22. In another example as illustrated in FIG. 2, the second end 22 remains spaced away from the first end 21.

FIG. 3 illustrates a protective hood 10 in another closed orientation. The lower section of the body 20 is folded onto an upper section of the body 20. The fold forms the open end 22 that leads into the interior space 24. The edge 25 is exposed on the outer side of the body 20. FIG. 3 includes a single fold in the body 20. Other designs can include the body 20 with two or more folds to reduce the length L from that of the open orientation.

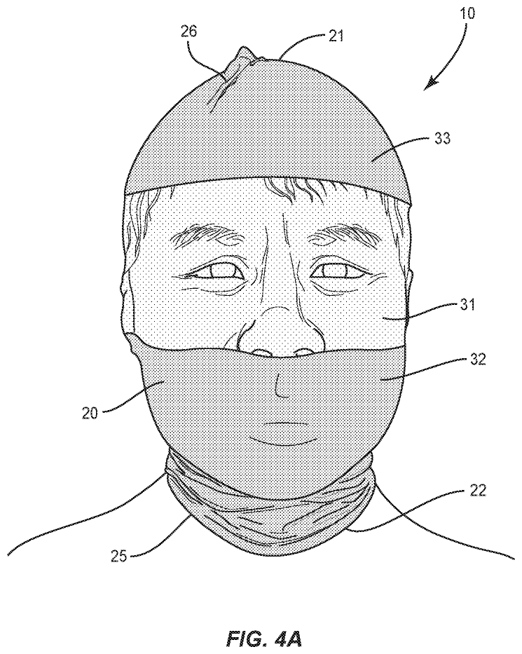

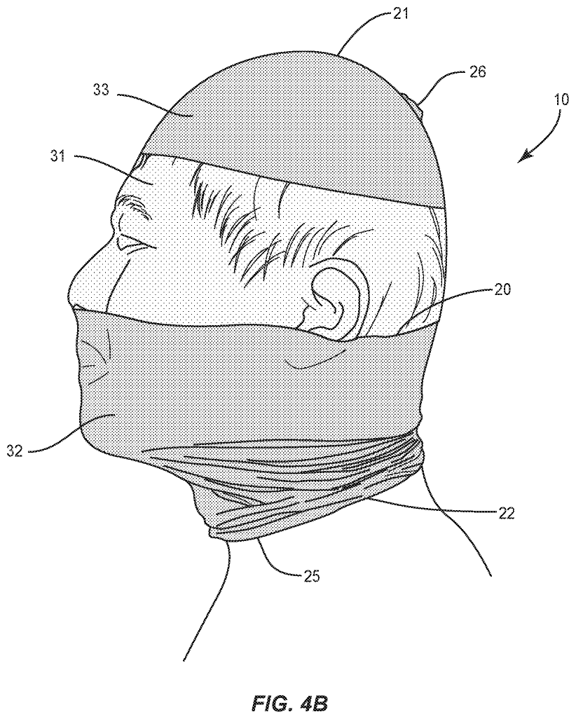

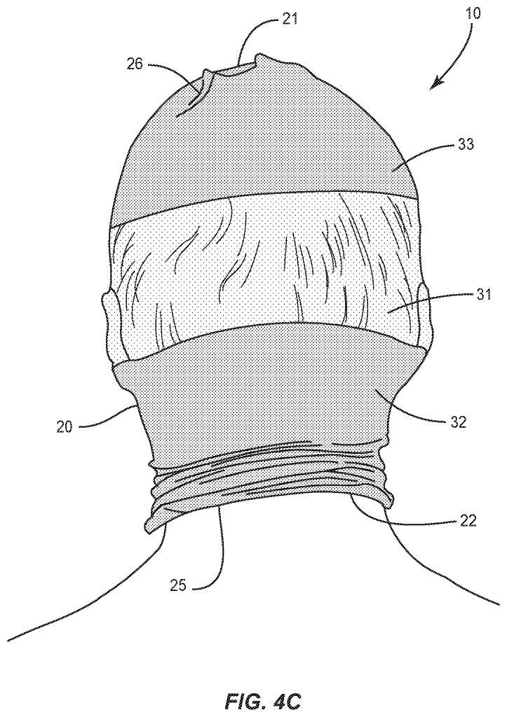

The first end 21 can be closed, such as by a seam 26 (see FIGS. 4A and 4B). The seam 26 can completely close the body 20, or an opening can be formed at the first end 21 with the opening being smaller than the open end 22 to prevent sliding down over the head of the person. In another design, the body 20 is formed with a closed end, such as by a knitting or weaving pattern that tapers and closes the first end 21.

In one example, the body 20 includes a tubular shape. The first end 21 is partially or completely closed, such as by a seam, mechanical fastener, adhesive, etc. In one example with the tube shape, the body 20 includes a constant width W along a substantial portion of the length L. In another example, the body 20 includes a tapered shape with the width W being smaller at the first end 21. FIG. 1 includes a body 20 having a variable width W along the length L. The different sections can have widths W to accommodate the anatomy of the person. For example, one section can be larger for the person's forehead, and a second section can be smaller for the neck.

In one example, the body 20 is constructed as a single, unitary member. One example includes the body 20 formed by a circular knitting process. Other examples include the body constructed from two or more pieces that are connected together. The connection can include various methods, including but not limited to one or more of stitching, adhesives, and mechanical fasteners.

The body 20 can be constructed to include various sections along the length L. The sections can include different constructions and provide for different functionality. FIGS. 4A-4C include the body 20 with different sections along the length L. The first section 31 is positioned to be aligned over the person's eyes. The first section 31 is configured for the person to see through to the outside environment. In one design, the first section 31 is constructed from a first knitting pattern with the spacing of the yarn providing for the person to see through to the outside environment 100. In one example, the first section 31 extends completely around the body 20 as illustrated in FIGS. 4A-4C. In another example, the first section 31 is positioned just at a front of the body 20 and does not extend completely around the body 20.

A second section 32 is positioned to be aligned with the person's mouth. The second section 32 is configured to prevent fluid from passing outward beyond the body 20 to the outside environment 100. In one design, the second section 32 is constructed from a second denser knitting pattern that prevents the passage of fluid beyond the second section 32. In another design, the second section 32 includes additional material and/or different material than the first section 31 to accomplish the different function.

In one example, the second section 32 extends completely around the body 20 as illustrated in FIGS. 4A-4C. In another example, the second section 32 extends just across the front of the body 20 to be aligned with the user's mouth.

The lengths of the sections 31, 32 can vary. FIGS. 4A-4C include the first section 31 positioned along the central section 23 of the body 20 and being spaced away from the end 21. Other examples include the first section 31 extending to the first end 21. The second section 32 is positioned between the first section 31 and the edge 25. In one design as illustrated, the second section 32 extends fully to the edge 25. Other designs include the second section 32 being spaced away from the edge 25.

One or more additional sections can be positioned along the length L of the body 20. The different sections can include various constructions that are the same or different than the first and second sections 31, 32. The protective hood 10 of Figures 4A-4C includes a third section 33 positioned at the first end 21 and extends to the first section 31. The third section 33 extends between the first end 21 and the first section 31. In one design, the third section 33 includes the same construction as the second section 32.

In another design, the construction of the body 20 is the same throughout the length L. This design does not include different sections. This single construction prevents the passage of fluid into the environment 100. The single construction may or may not provide for the person to see the environment 100.

The body 20 can be constructed from a variety of different materials. Examples include but are not limited to one or more of spandex, nylon, polyester, and polypropylene. Specific examples include a knit construction with a yarn of 95% nylon and 5% spandex, and a knit construction with a yarn of 90% nylon and 10% spandex.

In one design as illustrated in FIGS. 4A-4C, the body 20 can be elastic to tightly fit onto the head of the person. The body 20 can be stretched to an enlarged size to place onto the person, and then return towards its original shape and size against the person's head. The body 20 is constructed such that the section that extends over the person's mouth prevents or restricts the passage of fluid. The body 20 is further configured to allow for the person to breath, such as either through the section that is over the mouth and/or due to gaps between the body 20 and the person's head that allow for the passage of air.

In one design, an elastic member can be positioned at the edge 25. The elastic member can apply a force to the person's head and/or neck to maintain the position of the body 20. The elastic member can also prevent the open edge 25 from moving upward to where it could provide for the person's mouth to become exposed. The elastic member can be a single piece, or can be two or more pieces that are secured to the body 20. The elastic member can be secured in various manners such as sewing and adhesives.

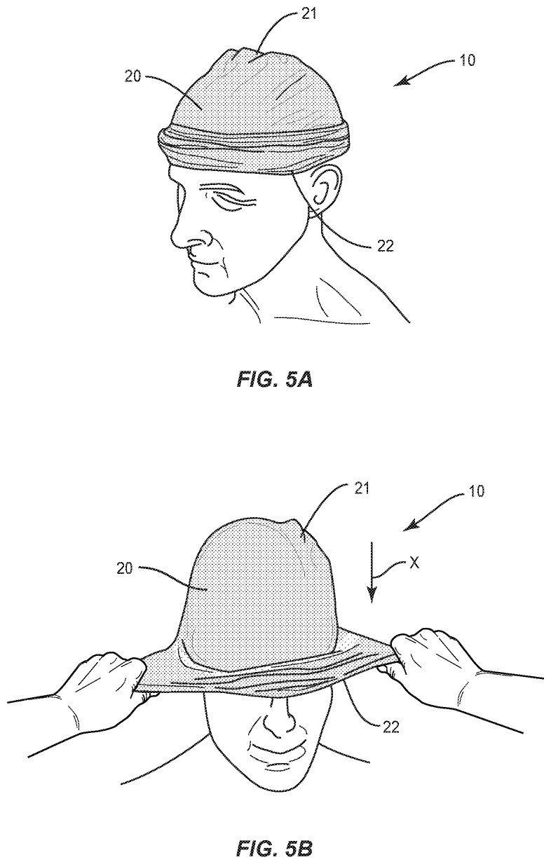

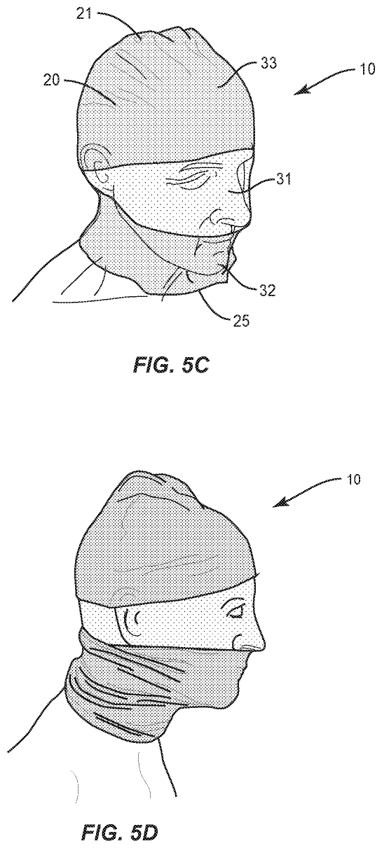

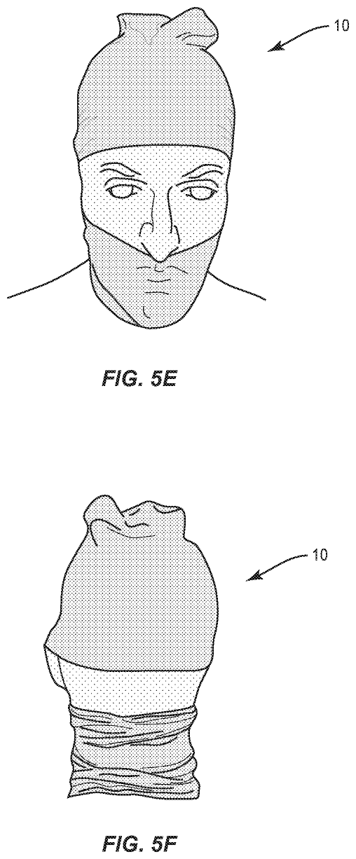

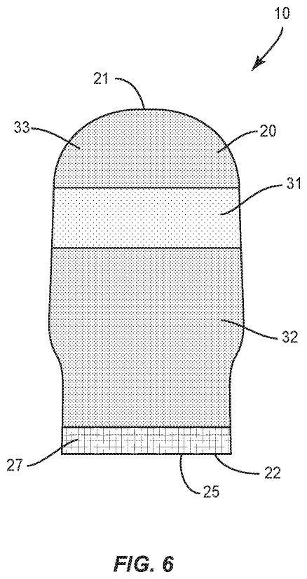

FIGS. 5A-5F illustrate a method of placing a protective hood 10 on a person. As illustrated in FIG. 5A, the protective hood 10 is initially in a closed orientation. This facilitates placement on the top of the person's head. The user's head is placed into the open second end 22 and the body 20 is pulled onto the person's head with the person's head being inserted into the interior space 24. The first end 21 is positioned at the top of the head. In one example, the size of the interior space 24 is expanded to fit onto the person's head. The body 20 applies a slight inward force that maintains the position on the person's head.

FIG. 5B illustrates the protective hood 10 being pulled farther onto the person. A section of the body 20 away from the first end 21, such as the edge 25, is pulled in the direction indicated by arrow X. This force causes the body 20 to open (e.g., to unroll or unfold) as it is moved along the person's head.

As illustrated in FIG. 5C, the body 20 is pulled onto the person's head with the edge 25 positioned along the person's neck. In this design, the second section 32 is aligned over the person's mouth to restrict spit or droplets from passing into the environment. The first section 31 is aligned over the person's eyes to allow for them to see into the environment 100.

FIG. 5D, 5E, and 5F illustrate the protective hood 10 positioned on the person.

The protective hood 10 is configured to be positioned on a user by another, such as personnel at an institution or a medical professional at a hospital or doctor's office. The protective hood 10 can also be positioned on the user by themselves, such as for a person as they enter a store or other public environment.

The protective hood 10 is applicable for use in a wide variety of contexts. One example includes an institutional facility, such as when transporting an inmate from a first location to a second location to prevent the inmate from spitting on another person in the environment 100. Other examples include but are not limited to a medical use, use while painting, and use while cleaning. In the various examples, the protective hood 10 can be used to restrict fluid or other elements expelled from the user's mouth from reaching the environment 100. The protective hood 10 can also be used to restrict elements in the environment from reaching the user's mouth.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive.

1. A protective hood sized to be positioned over a head of a user, the protective hood comprising:
a single unitary knitted body with a tubular shape comprising a closed first end and an open second end;
an interior space formed within the body and sized to receive the head of the user;
the tubular body comprising a first section with a first knitting pattern and positioned along the body to be aligned with eyes of the user to provide for the user to see when the head of the user is positioned in the interior space; and
the tubular body comprising a second section positioned between the first section and the second end, the second section comprising a second knitting pattern different than the first section and positioned along the body to be aligned with a mouth of the user to restrict passage of fluids from the mouth of the user through the second section.

2. The protective hood of claim 1, wherein the second knitting pattern is denser than the first knitting pattern.

3. The protective hood of claim 1, wherein the second section comprises additional material than the first section to restrict the passage of the fluids.

4. The protective hood of claim 1, wherein the tubular body further comprises a third section positioned between the first section and the closed end, the third section comprising the second knitting pattern.

5. The protective hood of claim 1, wherein the first section extends completely around the interior space.

6. The protective hood of claim 1, wherein each of the first and second sections extend completely around the body.

7. The protective hood of claim 1, further comprising a band at the second end, the band having a different visual appearance than a remainder of the body.

8. A protective hood sized to be positioned over a head of a user, the protective hood comprising:
a tubular body configured to receive the head of the user, the body comprising:
a first end;
an open end opposite from the first end, the open end comprising an edge;
a central section that extends between the edge and the first end and comprises a first section and a second section with the first section having a first construction that is see-through and a second section with a different construction that restricts passage of fluid;
the body movable between a closed orientation and an open orientation;
the closed orientation comprising the central section in an overlapping configuration with a length of the body measured between the first end and the edge being a first amount; and
the open orientation comprising the central section extended in a non-overlapping configuration with the length being greater than the first amount.

9. The protective hood of claim 8, wherein the body comprises a unitary construction.

10. The protective hood of claim 9, wherein the first section comprises a first knitting pattern and the second section comprises a second knitting pattern different than the first section.

11. The protective hood of claim 8, wherein the body comprises a third section that extends between the first section and the first end, the third section comprising a different construction than the first section.

12. The protective hood of claim 8, wherein each of the first section and the second section extend completely around the body.

13. The protective hood of claim 8, further comprising tabs positioned on opposing sides of the edge, the tabs being exposed in the closed orientation and extending outward beyond the open end.

14. The protective hood of claim 8, wherein the second section prevents the passage of fluids from the mouth of the user through the second section.

15. The protective hood of claim 8, wherein the first end is closed.

16. A method of using a protective hood on a user that is in an environment, the method comprising:
placing the hood on a top of a head of the user with the hood in a rolled orientation;
unrolling the hood and positioning a first section of the hood over eyes of the user, the first section having a first construction that allows the user to see through and into the environment;
unrolling the hood and positioning a second section of the hood over a mouth of the user, the second section having a different second construction that restricts passage of fluid from the mouth of the user out into the environment; and
positioning an open end of the hood below the user's mouth.

17. The method of claim 16, further comprising positioning a third section of the hood at the top of the head of the user with the third section having the same second construction as the second section.

18. The method of claim 16, further comprising expanding a size of an interior space of the hood and unrolling the hood from the top of the head of the user to below the mouth of the user.

19. The method of claim 16, further comprising placing the hood on the top of the head of the user with the hood in the rolled orientation and aligning tabs to extend outward from the hood.

20. The method of claim 16, further comprising positioning the first section completely around the head of the user.
